(19) United States
(12) Patent Application Publication
(10) Pub. No.: US 2015/0216160 A1
(43) Pub. Date: Aug. 6, 2015

(54) Animal Bite Deterrent Device

(71) Applicant: Alan Spence, Lexington, TX (US)

(72) Inventor: Alan Spence, Lexington, TX (US)

(21) Appl. No.: 14/606,141

(22) Filed: Jan. 27, 2015

Related U.S. Application Data
(60) Provisional application No. 61/935,979, filed on Feb. 5, 2014.

(51) Int. Cl. A01M 29/18; F21V 33/00; F21L 4/02

(52) U.S. Cl. CPC A01M 29/18; F21L 4/02; F21V 33/0076; F21Y 2101/02

(57) ABSTRACT

Disclosed are hand held devices for deterring aggressive animals containing a combination of an ultra bright LED light and an ultrasound generating component powered by a battery together with means to activate both. The devices may be configured to allow activation of one or both of the light and sound components disposed in a suitable housing. The devices, in some embodiments, has a structural design similar to a hand gun but optionally colored in such a way as to not be confused with a real firearm.

### CROSS REFERENCE TO RELATED APPLICATIONS

This application claims benefit of Provisional Application Ser. No. 61/935,979 filed Feb. 5, 2014. The contents and disclosures of the application are incorporated herein by reference in its entirety for all purposes.

### BACKGROUND

1. Field of Invention

The invention relates to deterrent of animal attacks, specifically to hand held devices for deterring animals from attacking and biting humans.

2. Background

According to the American Humane Association an estimated 4.7 million dog bites occur in the U.S. each year, 800,000 dog bites require medical care and approximately two-thirds of bites occurred on or near the victim's property, and most victims knew the dog. The insurance industry pays more than $1 billion in dog-bite claims each year. The U.S. Postal Service reported that 5,879 postal workers were victims of dog bites in fiscal year 2012. Dog bites to postal employees peaked during the mid-1980s when more than 7,000 letter carriers were attacked annually.

While this is a recognized problem, many animal control officers (ACO) departments will not allow their officers to carry an ASP (Bite Stick) or O.C. Spray, as an animal bite deterrent device for whatever reason. This leaves the ACO totally vulnerable to an attack by an aggressive dog or other animals unless they have something like a Catch/Control pole with them.

There are a number of animal deterrent devices available such as the Dog Dazer II Dog Deterrent and OnGuard™ devices that emit a high frequency sound audible to dogs but not to humans. DE 33161196, published Nov. 8, 1984 to Gerber described a device utilizing electronic frequencies in the ultrasonic range above 20000 Hz that are inaudible to humans. See also U.S. Pat. No. 6,250,255, published Jun. 26, 2001 describing pulsating or vibrating ultrasound for deterring animals.

However, all these devices are somewhat limited in effectiveness. The present invention overcomes many of those limitations and is designed specifically to be directly marketed to the vast animal care and control field, as well as postal and utility workers.

### SUMMARY

Devices of this invention are hand held devices containing a combination of an ultra bright LED light and an ultrasound generating component powered by a battery together with means to activate both. The devices may be configured to allow activation of one or both of the light and sound components disposed in a suitable housing. The devices, in some embodiments, has a structural design similar to a hand gun but optionally colored in such a way as to not be confused with a real firearm.

### DESCRIPTION OF FIGURES

A more complete understanding of the method and apparatus of the present invention may be had by reference to the following detailed description when taken in conjunction with the accompanying drawings, wherein:

FIG. 1 is perspective view of the exterior of an embodiment of the invention and some of the components.

FIG. 2 is a sectional view of an embodiment of the invention showing the arrangement of components.

FIG. 3 is an end view of the embodiment of FIGS. 1 and 2.

FIG. 4 is perspective view of the exterior of another embodiment of the invention and some of the components.

FIG. 4A is an end view of the device shown in FIG. 4

FIG. 5 is a sectional view of the embodiment shown in FIG. 4 showing the arrangement of components.

FIG. 6 is a schematic of the electrical system of an embodiment of the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION

In broad scope the devices of this invention in their embodiments are hand held devices containing a combination of an ultra bright LED light and an ultrasound generating component powered by a battery together with means to activate both. The device may be configured to allow activation of one or both of the light and a sound component disposed in a suitable housing.

The device, in some embodiments, has a structural design similar to “Taser” or “hand gun” but optionally colored in such a way as to not be confused with a real firearm. Holsters currently being manufactured may be used to carry/secure the device. The device will be activated very much like a Taser, except that there are no removable parts and it cost nothing to use. Upon deployment, (activating the trigger/switch component) a pulsating (or strobing) ultra-bright LED light (located in the forward end-muzzle of the device) is activated. Simultaneously activated will be an ultrasonic “whistle” (preferably three frequency), which only the dog can hear. Not all dogs respond to single frequency so three cycling frequencies are more effective. The frequency that dogs hear is between of 40 Hz to 60,000 Hz, whereas humans can only hear sounds approximately within the frequencies of 20 Hz and 20,000 Hz. An available ultrasonic whistle starts at the low range and stops at the peak Hz. The generator cycles through the three frequencies.

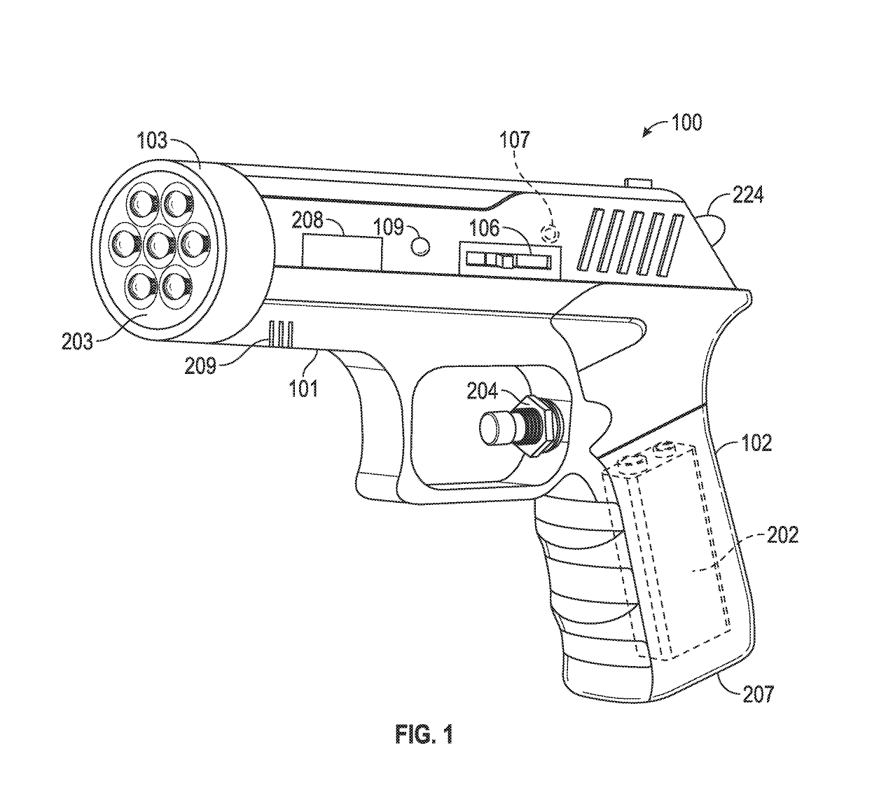

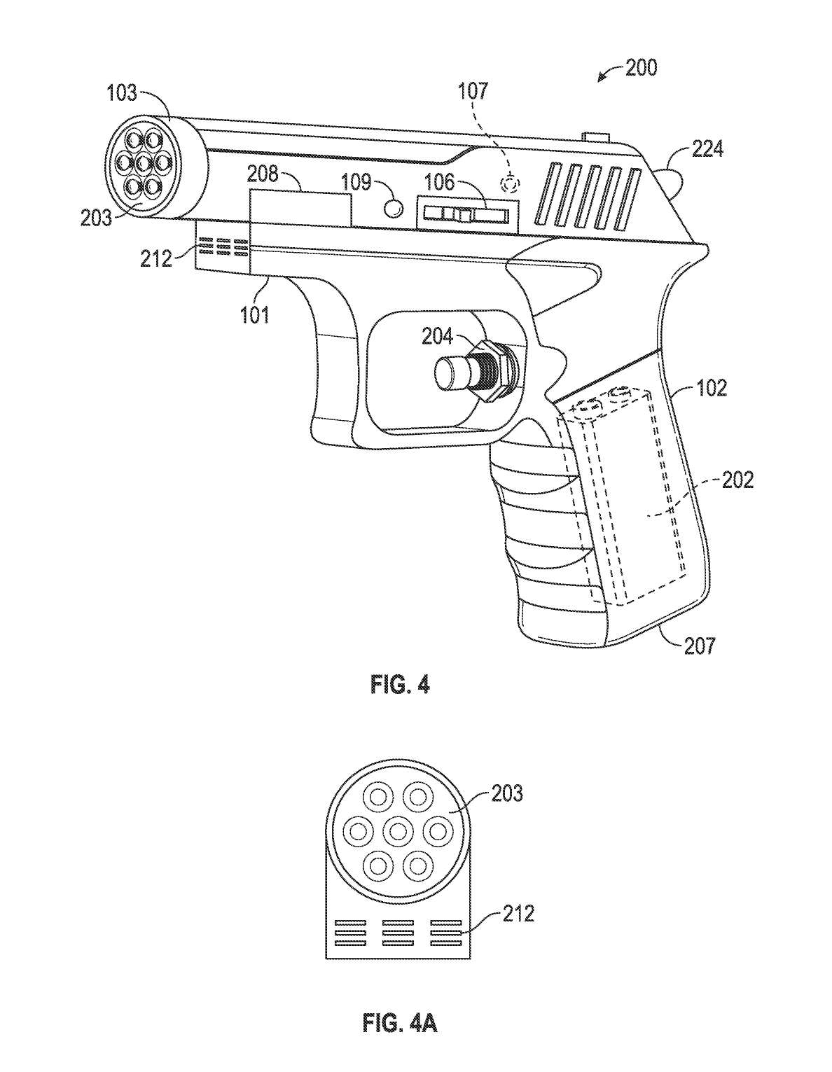

Referring to FIG. 1, there is illustrated an embodiment, 100, of the device configured in the shape of a handgun. FIG. 4 is another embodiment. The body 101 houses the device components and, in this embodiment) consists of four extruded (molded shell) plastic parts. A handgun shaped housing or body is a very practical and convenient. Such shape can, for example, be carried in a pistol holster or in any other manner that pistols/Tazer would be carried. But, the housing 101 may be of any suitable and convenient shape such as an elongated cylinder (flashlight casing). It may be housed in a walking cane head, “billy club” and any other housing that will be apparent to those skilled in the art. The body (housing), 101, may be constructed of any suitable material—polymer materials are preferred. It will conveniently be constructed of molded interlocking pieces or sections so that it can be dissembled for repair or replacement of internal components. The housing is preferably colored in a pattern to be easily distinguishable from a handgun or other device. For example is the illustrated pistol shaped body the barrel may be black and the handle a bright green, yellow, red and the like. The distal end on the barrel may also be of a different color.

The bulb end of a LED light array, 103, is disposed at the distal end of the barrel. The LED light, 203, is an ultra bright LED light array such as found in ultra bright flashlights. A super bright LED light with flashing strobe (preferred) that temporarily blinds and confuses the dog and helps stop the approach of unwanted dogs up to approximately 40 feet. Also has a training setting. An especially suitable LED light array is an array known as Advanced Focus System™ See information and description at www.ledlenser.com/on/demandware.store/Sites-leatherman-Site/en_US/Technology-Start.

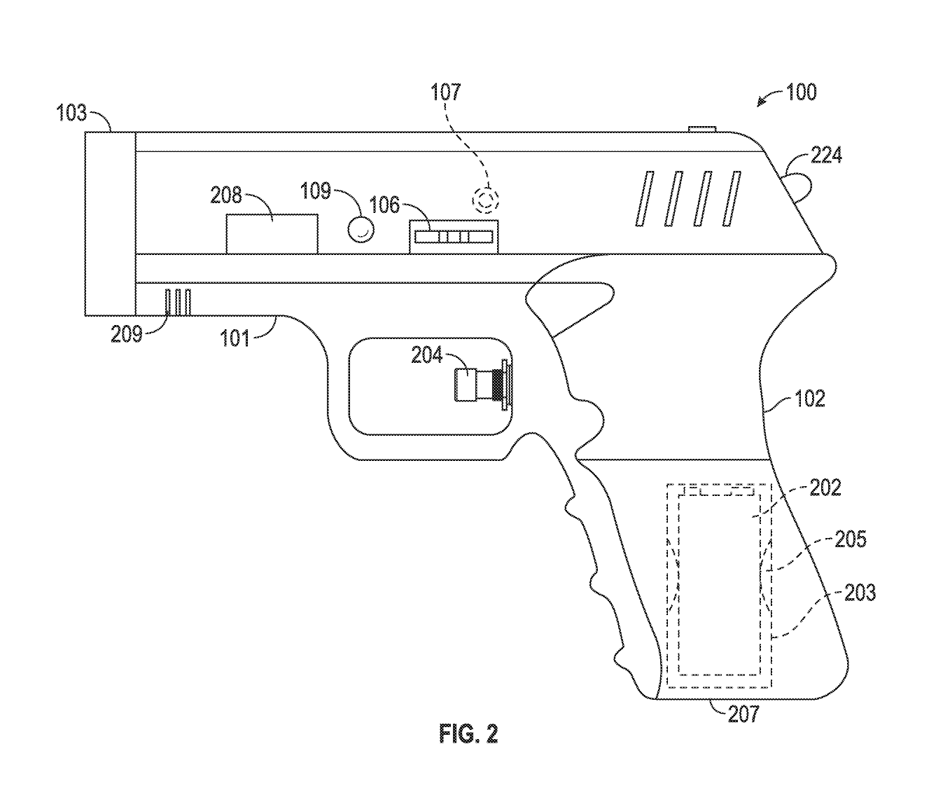

A battery 202 is fitted into a holding structure, 203 (in FIG. 2) in the handle of the pistol 102. An optional LED light to signal the battery status is shown as 109. In most applications a 3.5-9 v battery is sufficient.

There is also disposed in the housing, an ultrasound generator, 208, (preferably a pulsating three frequency ultrasonic “whistle”), which only the dog can hear. “Ultrasound is an oscillating sound pressure wave with a frequency greater than the upper limit of the human hearing range. Ultrasound is thus not separated from ‘normal’ (audible) sound based on differences in physical properties, only the fact that humans cannot hear it. Although this limit varies from person to person, it is approximately 20 kilohertz (20,000 hertz) in healthy, young adults. Ultrasound devices operate with frequencies from 20 kHz up to several gigahertz.” see information en.wikipedia.org/wiki/Ultrasound. There are slots 209 through which the sound is emitted. Item 224 is an optional feature for appearance and for steadying the device.

A three way switch, 106, controls the functions of the device. The center position of the switch allows both the LED light and Ultrasound generator to operate simultaneously when the activation button is depressed, allowing power from the battery to activate the LED (pulsating) light assembly and the ultrasonic “whistle” simultaneously. In the far left position, only the LED light is activated so it will act as a flashlight. In the far right position, the device is totally deactivated. The trigger is a push button switch 204.

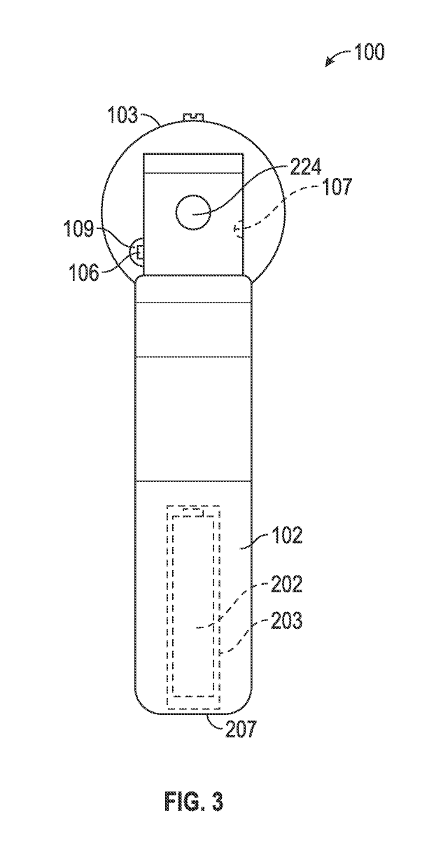

There is also, optionally, a low level LED light or a piezoelectric buzzer (107) to indicate when the ultrasound component is operating. There may also be an indicator for low battery. FIG. 2 is a sectional view of an embodiment of the invention showing the arrangement of the components. The device 100 is shaped like a handgun but other shapes are within the scope of the invention. There is a container, 203, in the base of the device 110 for the battery 202. A strip spring 205 holds the battery in place. There is also a butt cover, 207, to cover the bottom of the handle that may be attached in any convenient way, such as a sliding arrangement. The activation switch (trigger) is shown as item 204. An ultrasound generator 208 is disposed to focus sound out the bottom of the front (distal) end of the pistol. A LED light array 103 is positioned to be screwed into a receptacle in the front of the barrel. Both the LED light array and activation switch 204 may be configured to screw into a separate (e. g. metal or polymer square or rectangular pieces with female screw threads) component that will fit into recesses in the molded body to allow them to remain stable when the sections of the body are dissembled. FIG. 3 is an end view of the device of FIGS. 1-2.

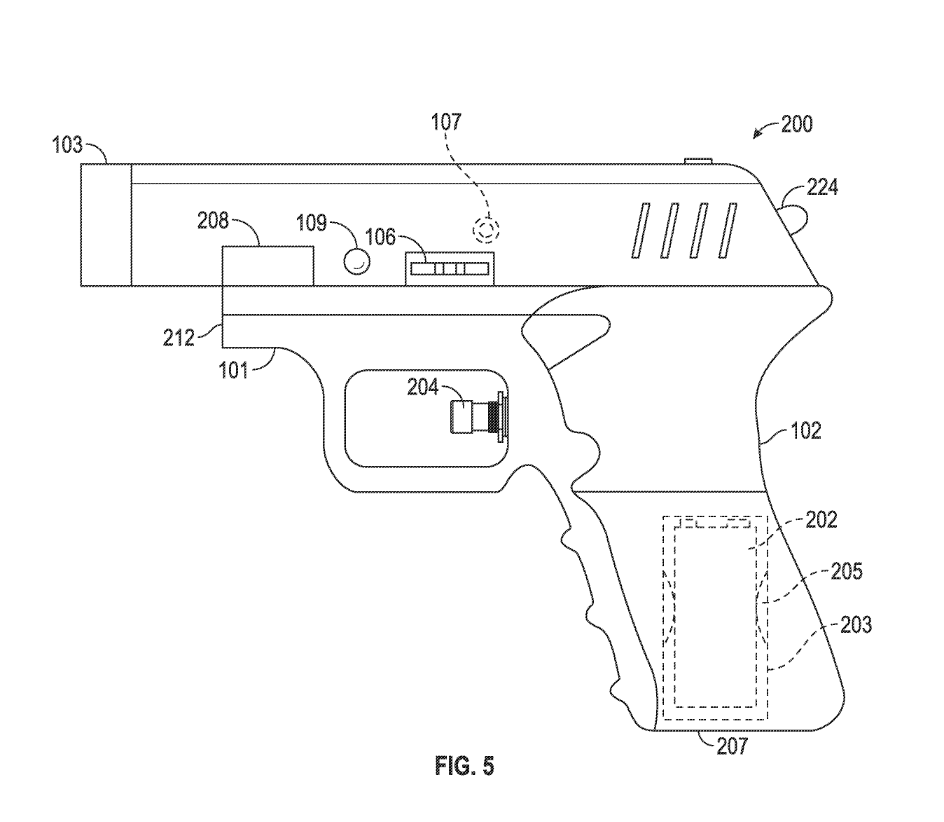

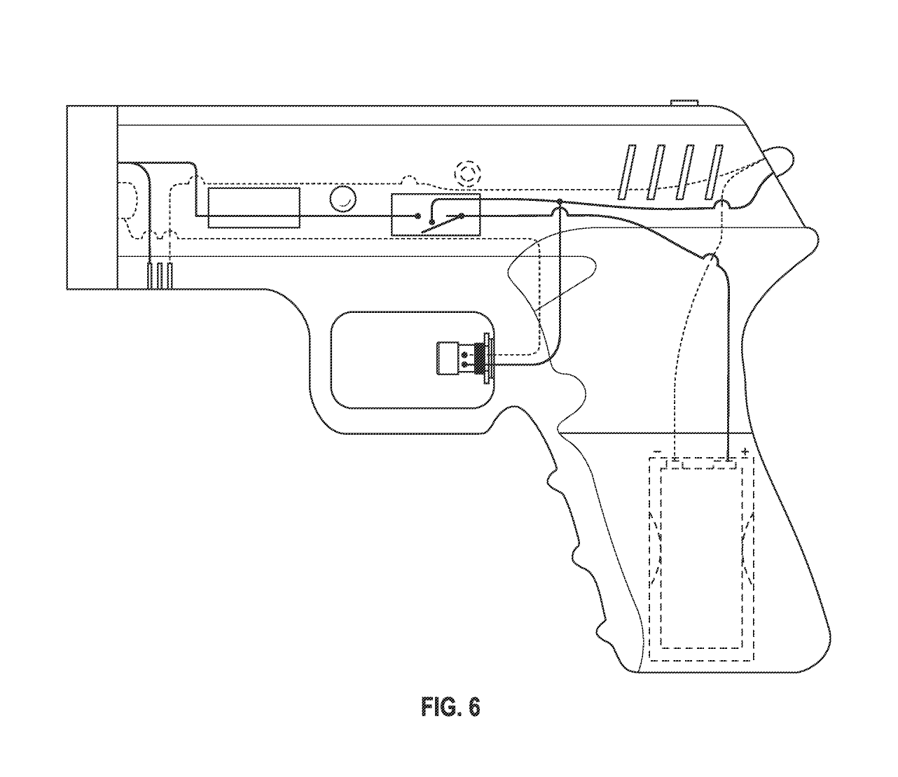

FIGS. 4, 4A and 5 illustrate another embodiment of the device of FIGS. 1-3 with a different arrangement for the barrel end. It is much like the device if FIGS. 1-3 except that the slots 221 for emitting sound are located at the end of the barrel support. FIG. 6 is an electrical diagram for the embodiments illustrated in FIGS. 1-5 showing how the components may be electrically connected. The heavy solid lines are the positive connections and the dotted lined the negative. The lines indicate how the battery, switches and LED light and ultrasonic generator re connected in this embodiment.

A prototype device as illustrated in the Figures was constructed with the following specified components:

4 extruded (molded shell) plastic parts.

1 LED light assembly,

2 LED micro indicator lights

2 micro switches,

1 momentary N/O switch (trigger)

1 ultrasonic device

1 integrated circuit board (optional depending on LED array configuration)

1 3.5-9 volt battery (power supply)

The device as illustrated may be worn as a part of their everyday duty equipment, such as a “Bite Stick” or O.C. Spray, similar to the way a peace officer would carry a Taser. It is recommended the device be carried in a holster for security ready immediate deployment. In operation the device may be also used as a distraction for a vicious animal if the light and sound proves ineffective. If the animal (dog) attack is not deterred, by the activation of device, the ACO could actually “FEED” the device to the animal in order to proceed with deploying his/her bite stick.

Although the invention hereof has been described by way of specific embodiments, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

1. An animal deterrent device comprising:
a housing for components;
an ultra bright LED light array disposed in the housing;
an ultrasound generator disposed in the housing to focus the signal towards the distal end of the housing; and
activation means for both the LED light and ultrasound generator; and
a battery for providing electrical current to the other components.

2. The device of claim 1 wherein the ultrasound generator is capable of generating pulsing ultrasound waves of above about 20 kHz.

3. The device of claim 1 comprising indicator lights or sounds that indicate when the ultrasound generator is operating and when the battery is low.

4. The device of claim 1 wherein the housing is shaped as a handgun or a flashlight.

5. The device of claim 1 wherein the animal is a dog.

6. The device of claim 1 wherein the housing is constructed of interlocking molded polymer sections.

7. The device of claim 1 wherein the ultra bright LED light is a three frequency strobe light.

8. A method of repelling animals by providing a device comprising:
pointing the device at an animal and activating either the ultrasound generator, the ultra bright LED light or both a housing for components; wherein the device comprises:
an ultra bright LED light array disposed in the housing;
an ultrasound generator disposed in the housing to focus the signal towards the distal end of the housing;
activation means for both the LED light and ultrasound generator;
a battery for providing electrical current to the other components.

9. The method of claim 8 wherein the animal is a dog and the ultrasound generator is capable of generation ultrasound wave of above about 20 kHz.

10. The method of claim 8 comprising indicator lights or sounds that indicate when the ultrasound generator is operating and when the battery is low.

11. The method of claim 8 wherein the housing is shaped as a handgun or flashlight.

12. The device of claim 8 wherein the animal is a dog and the ultra bright LED light is a three frequency strobe light.
